(19) United States
(12) Patent Application Publication
(10) Pub. No.: US 2008/0092193 A1
(43) Pub. Date: Apr. 17, 2008

(54) Methods and systems for creating video files for a mobile device

(75) Inventors: Lisa Marie Lee, St. Louis, MO (US); Tara Denean Robinson, St. Louis, MO (US)

Correspondence Address: PATRICK W. RASCHE;ARMSTRONG TEASDALE LLP, ONE METROPOLITAN SQUARE, SUITE 2600, ST. LOUIS, MO, 63102-2740, US

(73) Assignee: The Video Load, LLC

(21) Appl. No.: 11/787,514

(22) Filed: Apr. 17, 2007

Related U.S. Application Data
(60) Provisional application No. 60/852,226, filed on Oct. 17, 2006.

(51) Int. Cl. H04N 7/173

(52) U.S. Cl. 725/123; 715/723

(57) ABSTRACT

A method for creating a video clip for a mobile device using a video processing system is provided. The method includes uploading at least one video file to the video processing system, the video processing system including a video editor module, editing using the video editor module to produce a video clip from the video file, saving the video clip to a video processing system database, and downloading the video clip to a client system.

### CROSS REFERENCE TO RELATED APPLICATIONS

This nonprovisional application claims the benefit of U.S. Provisional Application Ser. No. 60/852,226, filed Oct. 17, 2006 which is hereby incorporated by reference in its entirety.

### BACKGROUND OF THE INVENTION

This invention relates generally to uploading and downloading data content to a mobile network and, more particularly, to internet-based methods and systems for managing, creating, modifying and distributing media and video files to a mobile networking device.

Data files have become widely sought after by users of wireless mobile network devices. Users prefer to personalize the operation of these devices. Such personalizations include, for example, loading media files onto these wireless devices. For example, users of mobile, wireless telephones sometimes like to personalize the ring tone of their wireless telephone. These ring tones may be generated using data files such as music files. In other words, when a user of a mobile, wireless telephone having a personalized ring tone that includes a music data filed stored thereon receives an incoming telephone call, the data file stored on the wireless telephone is activated causing the wireless telephone to sound a ring tone (i.e., play music) and alerting the user that a telephone call is incoming.

Although there are some known systems for creating music ring tones, there are limited consistent and reliable processes for users of mobile devices to manage, create, modify and distribute personalized media and video files for use on such mobile devices.

### BRIEF DESCRIPTION OF THE INVENTION

In one aspect, a method for creating a video clip for a mobile device using a video processing system is provided. The method includes uploading at least one video file to the video processing system, the video processing system including a video editor module, editing using the video editor module to produce a video clip from the video file, saving the video clip to a video processing system database, and downloading the video clip to a client system.

In another aspect, a network-based system for creating a video clip for a mobile device is provided. The network-based system includes a client system including a browser, a video processing system database for storing information, and a video processing system communicatively coupled to the client system and the video processing system database. The video processing system includes a video editor module for editing video files. The video processing system is configured to upload at least one video file to the video processing system, edit the video file using the video editor module to produce a video clip from the video file, save the video clip to the video processing system database, and download the video clip to the client system.

In a further aspect, a server system for creating a video clip for a mobile device is provided. The server system is communicatively coupled to a client system and a video processing system database. The server system is configured to upload at least one video file to a video processing system that includes a video editor module. The server system is also configured to edit the video file using the video editor module to produce a video clip, save the video clip to the video processing system database, and download the video clip to the client system.

### BRIEF DESCRIPTION OF THE DRAWINGS

FIG. 1 is a simplified block diagram of a video processing system.

FIG. 2 is an expanded block diagram of an exemplary embodiment of a server architecture of a video processing system.

FIG. 3 is a flowchart illustrating exemplary processes utilized by a video processing system.

FIG. 4 is a flowchart illustrating exemplary processes utilized by a video processing system.

FIG. 5 is a flowchart illustrating exemplary processes utilized by a video processing system.

FIG. 6 is an example embodiment of a user interface displaying an option screen for loading files within a video processing system.

FIG. 7 is an example embodiment of a user interface displaying an upload screen for file content within a video processing system.

FIG. 8 is another example embodiment of a user interface displaying an upload screen for file content within a video processing system.

FIG. 9 is another example embodiment of a user interface displaying an upload screen for file content within a video processing system.

FIG. 10 is an example embodiment of a user interface displaying a download screen having a payment method and file format within a video processing system.

FIG. 11 is an example embodiment of a user interface displaying a download screen having terms and conditions within a video processing system.

FIG. 12 is an example embodiment of a user interface displaying a download screen for reviewing an order within a video processing system.

FIG. 13 is an example embodiment of a user interface displaying a download screen for downloading and showing receipt within a video processing system.

FIG. 14 is an example embodiment of a user interface displaying a video clip screen for creating a video clip within a video processing system.

FIG. 15 is an example embodiment of a user interface displaying a video clip screen for recording video clip within a video processing system.

FIG. 16 is an example embodiment of a user interface displaying a video clip screen for previewing video clip within a video processing system.

FIG. 17 is an example embodiment of a user interface displaying a video clip screen for saving a video clip within a video processing system.

FIG. 18 is an example embodiment of a user interface displaying a video clip screen for selecting a mobile device within a video processing system.

FIG. 19 is an example embodiment of a user interface displaying a video clip screen for selecting a payment method within a video processing system.

FIG. 20 is an example embodiment of a user interface displaying a video clip screen for reviewing an order within a video processing system.

FIG. 21 is an example embodiment of a user interface displaying a video clip screen for downloading video clip from a video processing system.

### DETAILED DESCRIPTION OF THE INVENTION

Exemplary embodiments of systems and processes that facilitate integrated network-based electronic reporting and facilitate managing, creating, modifying, and distributing media content including video files are described below in detail. The systems and processes facilitate, for example, electronic submission of information using a client system, automated extraction of information, and web-based reporting for internal and external system users. A technical effect of the systems and processes described herein include at least one of uploading data files including video files, downloading video files, and creating video clips from video files for use on a mobile device. More specifically, in the example embodiment, a user that is interested in creating a personalized video ring tone for their wireless telephone would utilize the video processing system to upload a video file, record a video clip from the video file, preview the video clip, edit the video clip, save the video clip, select a wireless mobile device manufacturer and model so that video clip can be downloaded in the proper format, and download the video clip to the user's client system. The user can then load the downloaded video clip into their wireless device for use as a video ring tone. After the video clip has been created and saved to the video processing system, the user can then upload the video clip to the system so that other users may purchase and utilize the created video clip for their own mobile devices.

In one embodiment, a computer program is provided, and the program is embodied on a computer readable medium and utilizes a Structured Query Language (SQL) with a client user interface front-end for administration and a web interface for standard user input and reports. In an exemplary embodiment, the system is web enabled and is run on a business-entity intranet. In yet another embodiment, the system is fuilly accessed by individuals having an authorized access outside the firewall of the business-entity through the Internet. In a further exemplary embodiment, the system is being run in a Windows ® environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

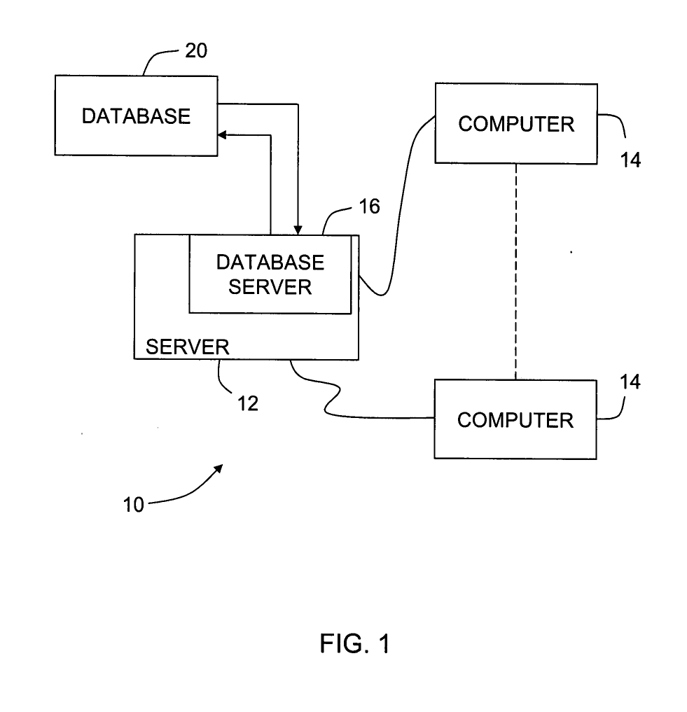

FIG. 1 is a simplified block diagram of a video processing system 10 including a server system 12, and a plurality of client sub-systems, also referred to as client systems 14, connected to server system 12. System 10 includes a video distribution module and a video editor module. Video and/or media files, as described below in more detail, are stored in server 12 and can be accessed by a user at any one of computers 14. In one embodiment, client systems 14 are computers including a web browser, such that server system 12 is accessible to client systems 14 using the Internet. Client systems 14 are interconnected to the Internet through many interfaces including a network, such as a local area network (LAN) or a wide area network (WAN), dial-in-connections, cable modems and special high-speed ISDN lines. Client systems 14 could be any device capable of interconnecting to the Internet including a web-based phone, personal digital assistant (PDA), or other web-based connectable equipment. A database server 16 is connected to a database 20 containing information on a variety of matters, as described below in greater detail. In one embodiment, centralized database 20 is stored on server system 12 and can be accessed by potential users at one of client systems 14 by logging onto server system 12 through one of client systems 14. In an alternative embodiment, database 20 is stored remotely from server system 12 and may be non-centralized.

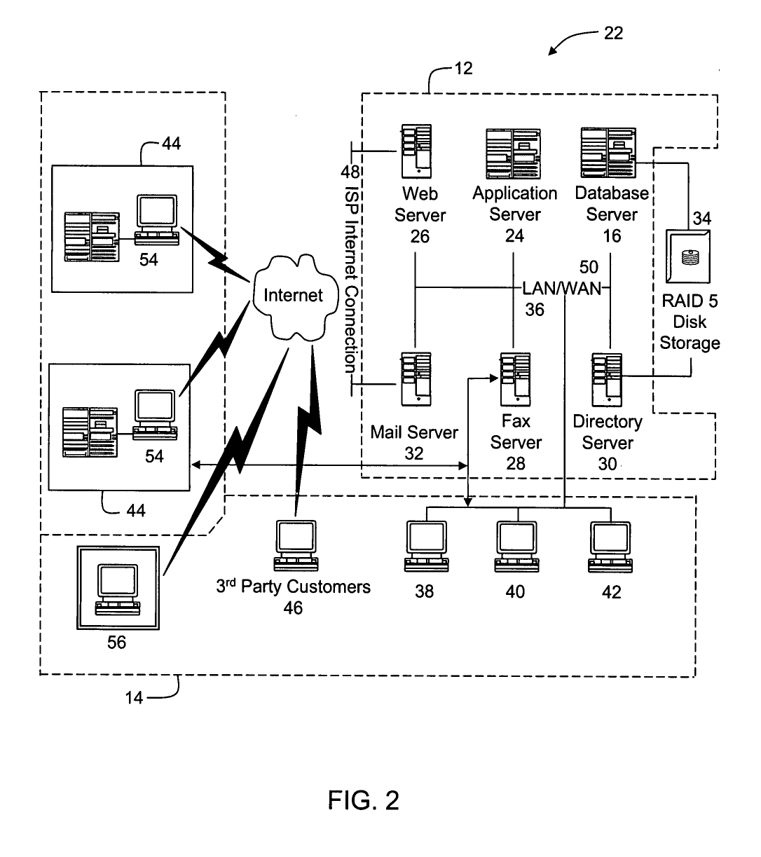

FIG. 2 is an expanded block diagram of an exemplary embodiment of a server architecture of a video processing system 22. Components in system 22, identical to components of system 10 (shown in FIG. 1), are identified in FIG. 2 using the same reference numerals as used in FIG. 1. System 22 includes server system 12 and client systems 14. Server system 12 further includes database server 16, an application server 24, a web server 26, a fax server 28, a directory server 30, and a mail server 32. A disk storage unit 34 is coupled to database server 16 and directory server 30. Servers 16, 24, 26, 28, 30, and 32 are coupled in a local area network (LAN) 36. In addition, a system administrator's workstation 38, a user workstation 40, and a supervisor's workstation 42 are coupled to LAN 36. Alternatively, workstations 38, 40, and 42 are coupled to LAN 36 using an Internet link or are connected through an Intranet.

Each workstation, 38, 40, and 42 is a personal computer having a web browser. Although the functions performed at the workstations typically are illustrated as being performed at respective workstations 38, 40, and 42, such functions can be performed at one of many personal computers coupled to LAN 36. Workstations 38, 40, and 42 are illustrated as being associated with separate functions only to facilitate an understanding of the different types of functions that can be performed by individuals having access to LAN 36.

Server system 12 is configured to be communicatively coupled to various individuals, including employees 44 and to third parties, e.g., clients/customers, 46 using an ISP Internet connection 48. The communication in the exemplary embodiment is illustrated as being performed using the Internet, however, any other wide area network (WAN) type communication can be utilized in other embodiments, i.e., the systems and processes are not limited to being practiced using the Internet. In addition, and rather than WAN 50, local area network 36 could be used in place of WAN 50.

In the exemplary embodiment, any authorized individual having a workstation 54 can access Video Creator System 22. At least one of the client systems includes a manager workstation 56 located at a remote location. Workstations 54 and 56 are personal computers having a web browser. Also, workstations 54 and 56 are configured to communicate with server system 12. Furthermore, fax server 28 communicates with remotely located client systems, including a client system 56 using a telephone link. Fax server 28 is configured to communicate with other client systems 38, 40, and 42 as well.

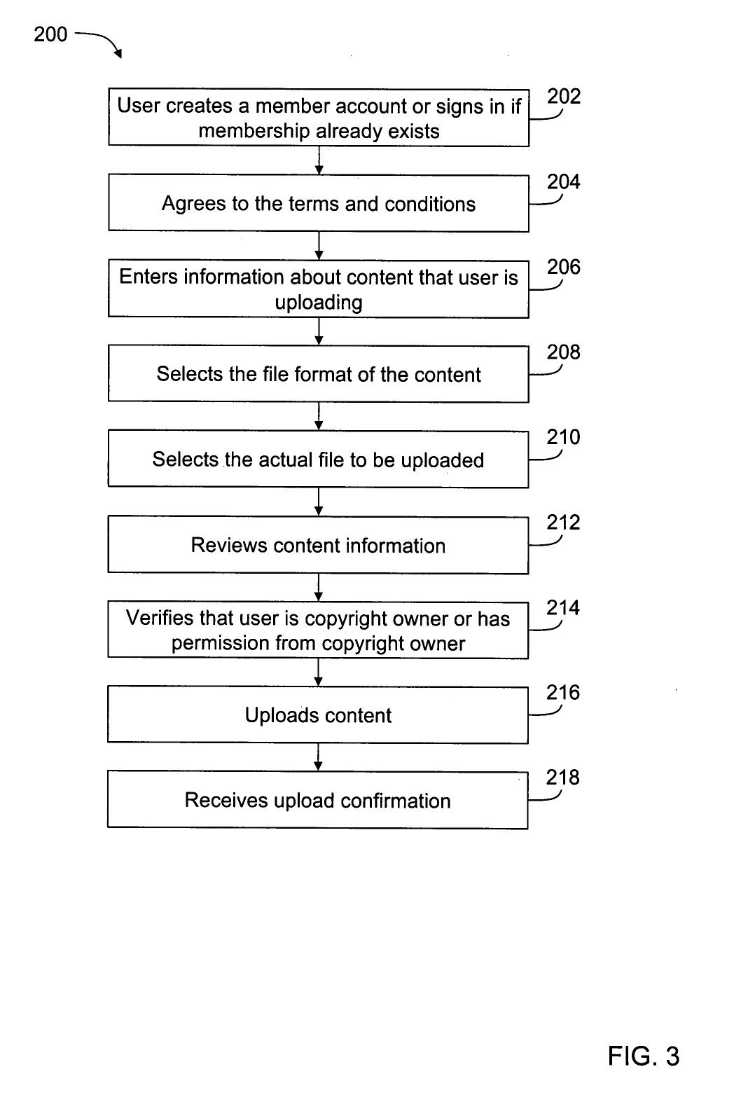

FIG. 3 is a flowchart 200 illustrating an exemplary process of uploading a video utilized by the video processing system 10 (shown in FIG. 1). The technical effect of the processes and systems described herein is achieved when the user creates 202 a member account within the system 10. The user creates 202 the member account, so that the user may have access to the video files contained within the video processing system 10, and more specifically, within the video distribution module. The created 202 member account also allows for the user to be compensated whenever the user's videos are purchased by any other user. If the user is already a member, the user signs 202 into the account already in existence. The user agrees 204 to the terms and conditions of the video processing system 10, for example, operating practices of the system. After agreeing 204, the user enters 206 information about the files the user is to upload. The user enters 206 information including, but not limited to, title, matter content, and category. The user then selects 208 the format of the file to be uploaded. The user selects 210 the exact file to be uploaded. After the selection the user reviews 212 the file content information to ensure that the information is correct. The user then verifies 214 user is the owner of the video file or has the right to use the video file in the manner in which it is being used. Preferably, verification of ownership or right to use is requested only when the user is initially creating a new member account. The user uploads 216 the file content and receives 218 confirmation the file has been uploaded. In another embodiment a content management administrator verifies the ownership of the video files uploaded and saved on system 10.

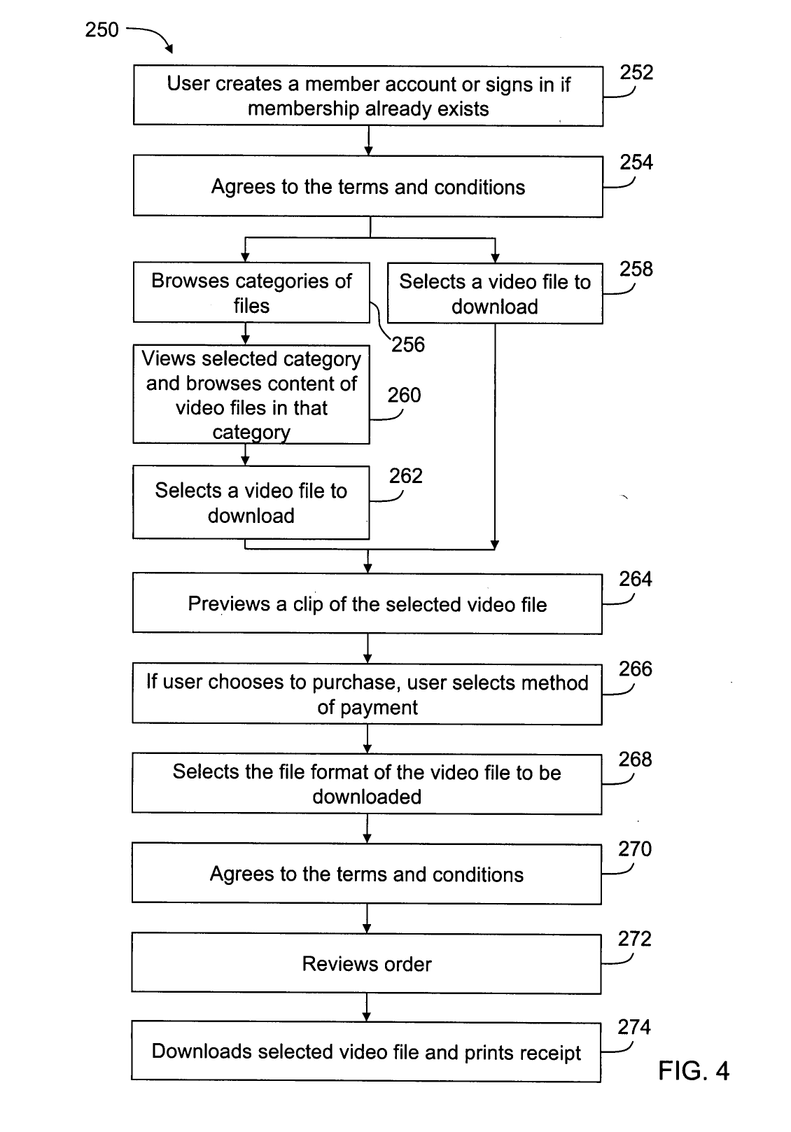

FIG. 4 is a flowchart 250 illustrating the exemplary process of downloading a video utilized by the video processing system 10 (shown in FIG. 1). The technical effect of the processes and systems described herein is achieved when the user creates 252 a member account within the system 10. The user creates 252 the member account to have access to the video files contained in the system 10, and more specifically, within the video distribution module. The created 252 member account allows the user to be compensated whenever the user's videos are purchased by another user. The user agrees 254 to the terms and conditions of the system 10, for example, operating practices of the system. The user is then able to browse 256 categories or directly selects 258 a video file to download.

If the user browses 256 the categories, the user will be able to view 260 different categories and the content of the video files therein. The user makes 262 a selection to download from the categories the user was browsing 256. The user previews 264 a clip of the file the user has selected to download.

If the user directly selects 258 a file, the user is able to preview 264 a clip of the file the user has selected.

After previewing 264 the file, if the user decides to purchase the selection, the user selects 266 the method of payment. The user may select 266, for example, to purchase the download with a credit card or the like. In another embodiment, video coins are used as a method of payment. The user purchases the video coins on the website. These video coins are credits which the user can purchase video file downloads and create video clip files.

After the user selects 266 the method of payment, the user chooses 268 the format in which the user would like to download the file, for example, but not limited to, MPEG format or AVI (Audio Visual Interleave) format. The user agrees 270 to the terms and conditions of the download. The user reviews 272 the order to ensure everything is correct. Finally, the user downloads 274 the file and prints out the receipt.

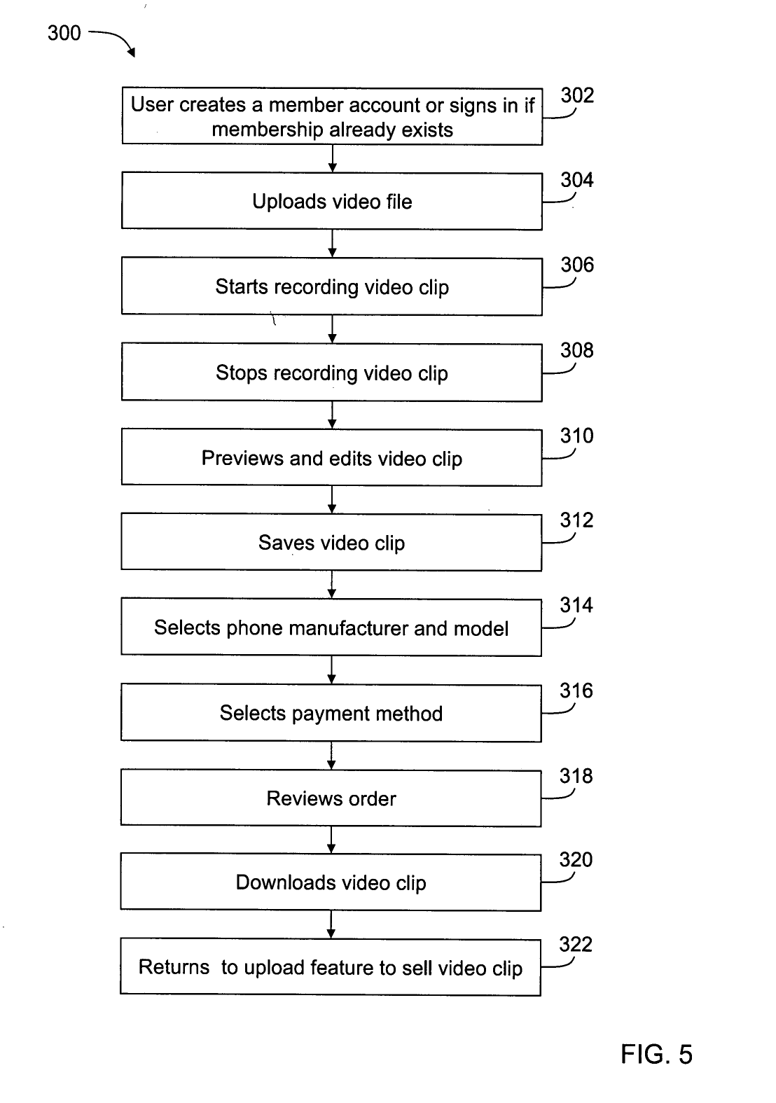

FIG. 5 is a flowchart 300 illustrating the exemplary process of recording a clip of a video file utilized by the video processing system 10 (shown in FIG. 1). The technical effect of the processes and systems described herein is achieved when the user creates 302 a new account. The user uploads 304 a video file to the video editor module. The video file can be any type of data file or other media file wherein the user is the owner of the video file or has the right to use the video file in the manner in which it is being used on the system 10. For example, with respect to each video file uploaded into the video editor module, the user must verify that they are the owner of the video file or have the right to use the video file from the owner. Once uploaded, the user then starts 306 to record a video clip from the uploaded video file. After the user has recorded the video clip, the user stops 308 recording. The user is then able to preview 310 and edit the video clip. The user then saves 312 the video clip to a database associated with system 10.

After the video clip is saved 312, the user selects 314 the wireless mobile device manufacturer and model. The user selects the mobile device manufacturer and model of the device the user is going to store the video clip thereon. By making this selection, the user is ensured that the video clip is saved in the proper format for use on the wireless device. The user selects 316 the method of payment. The user then reviews 318 the order to be sure all the information is correct, and the user then downloads 320 the video clip to a client system. The user is able to return 322 back to the upload flowchart 200 (shown in FIG. 3) to upload the video clip to system 10 and sell the video clip to other users.

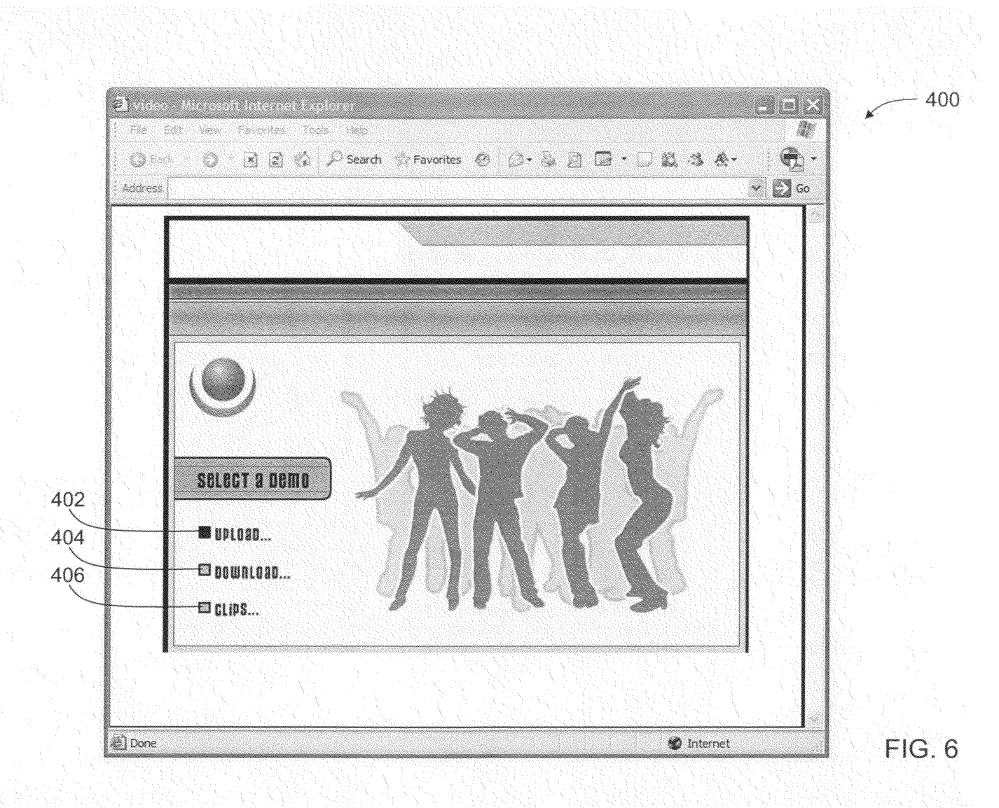

FIG. 6 is an example embodiment of a video loading screen 400. Screen 400 is displayed for a user within video processing system 10 (shown in FIG. 1) after the user has logged onto system 10. Screen 400 includes an upload link 402, a download link 404, and a video clip link 406.

Upon logging into system 10, screen 400 is displayed. The screen prompts a user by displaying certain links to be selected by the user. What is displayed in the screen for the user is reflective of the user's role in the uploading, downloading, and editing process.

In the example embodiment, screen 400 lists actions to be completed by the user. Upload link 402 allows the user to begin the process of uploading video files. Download link 404 allows the user to begin the process of downloading video files. Video clip link 406 allows the user to upload video files and then record video clips from those files. Upload link 402 and download link 404 are part of the video distribution module, and video clip link 406 is part of the video editor module within the system 10.

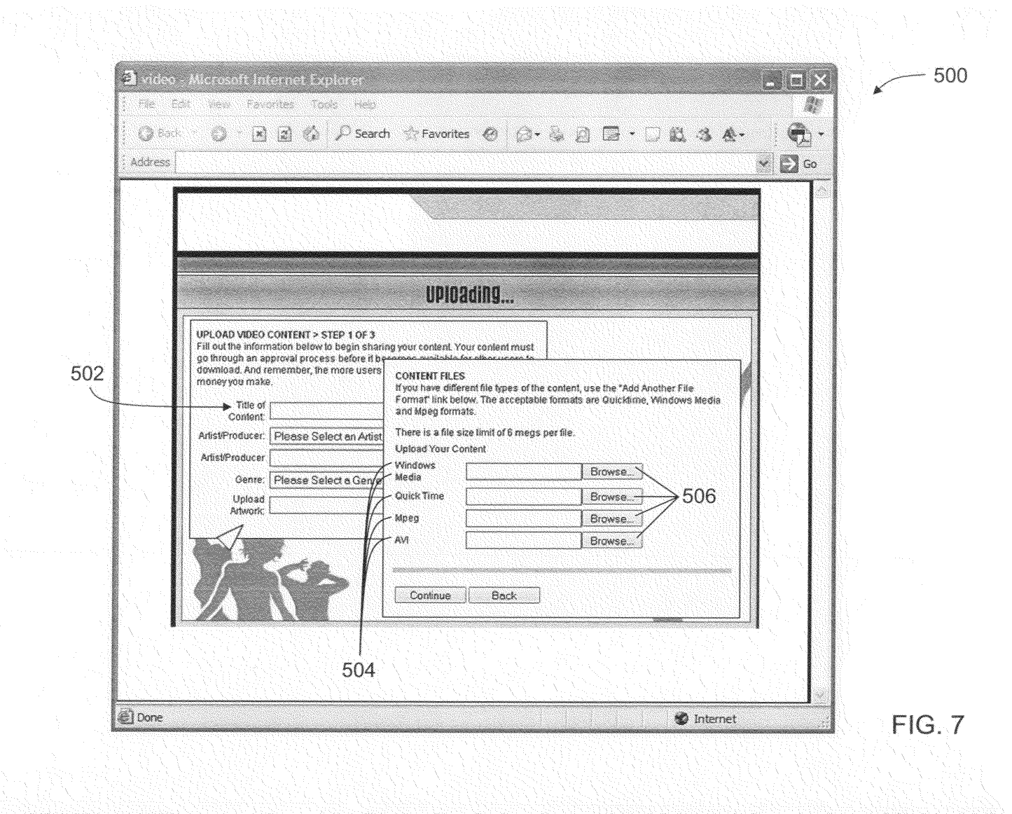

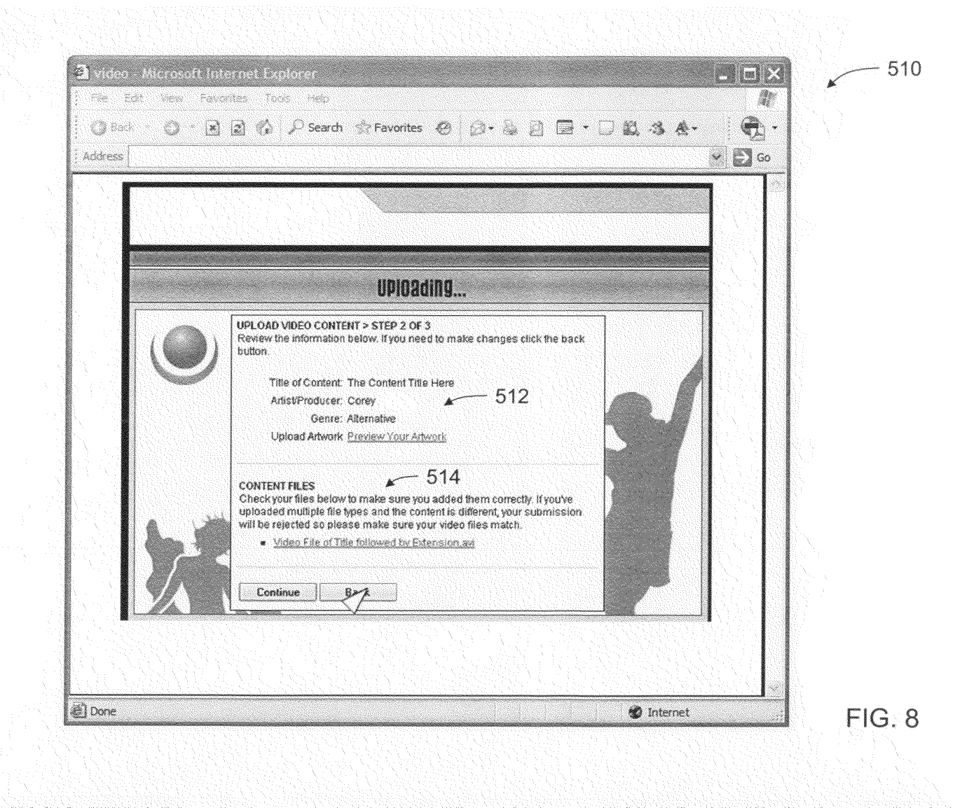

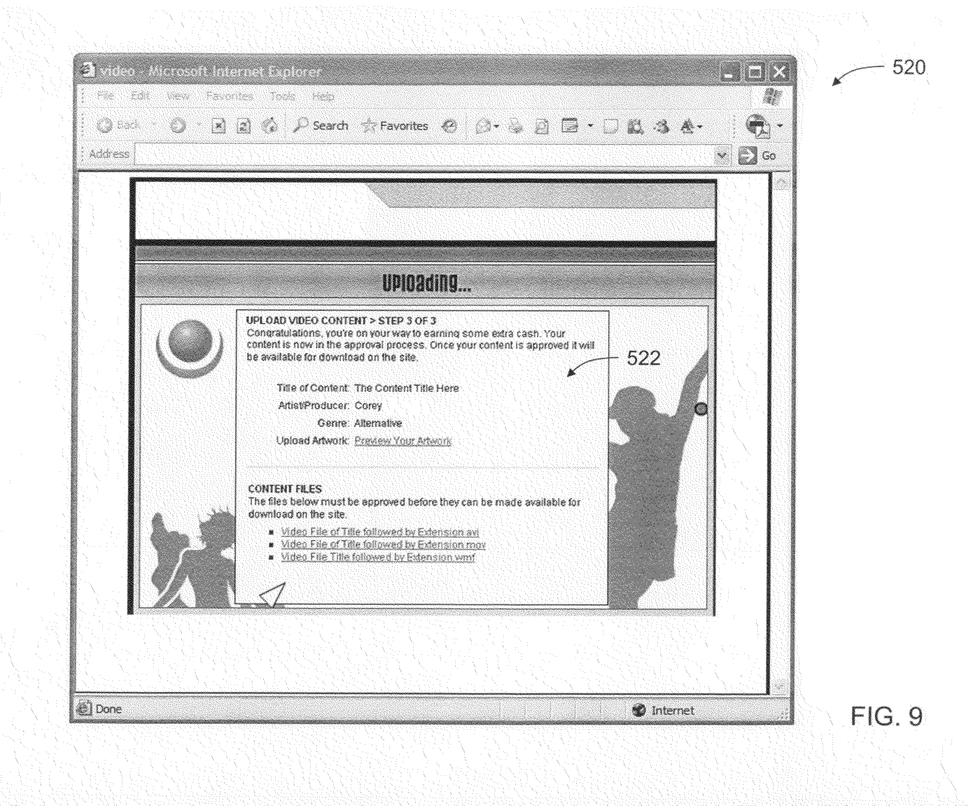

FIGS. 7-9 are example embodiments of upload screens 500, 510, and 520 within system 10 (shown in FIG. 1). In FIG. 7, upload screen 500 includes file content 502, file format 504, and file 506. In FIG. 8, upload screen 510 includes content information 512 and file type information 514. In FIG. 9, upload screen 520 includes content confirmation 522.

Upon logging into system 10, upload screens 500, 510, and 520 are displayed in system 10. These screens list links to be performed or selected by the user. What is displayed on the screens for the user is reflective of the user's role in the uploading.

FIG. 7 is an example embodiment of upload screen 500, which displays links to be performed and selected by the user. File content 502 requires the input of information describing the file to be uploaded. The file format 504 indicates where the files are being uploaded from and the computer program used to operate the program. File 506 is the actual file uploaded into system 10.

FIG. 8 is an example embodiment of upload screen 510, which displays links to be performed and selected. Content information 512 contains inputted information for the user's review. The user reviews the content 512 to ensure the information is correct. The user verifies the video file owner information 514, to verify user is the owner of the video file or has the right to use the video file in the manner in which it is being used. Preferably, verification of ownership or right to use is requested only when the user is initially creating a new member account.

FIG. 9 is an example embodiment of upload screen 520, which displays content confirmation 522 to verify to the user that the video file has been uploaded. When an uploaded video is purchased, the user receives a percent of the sale.

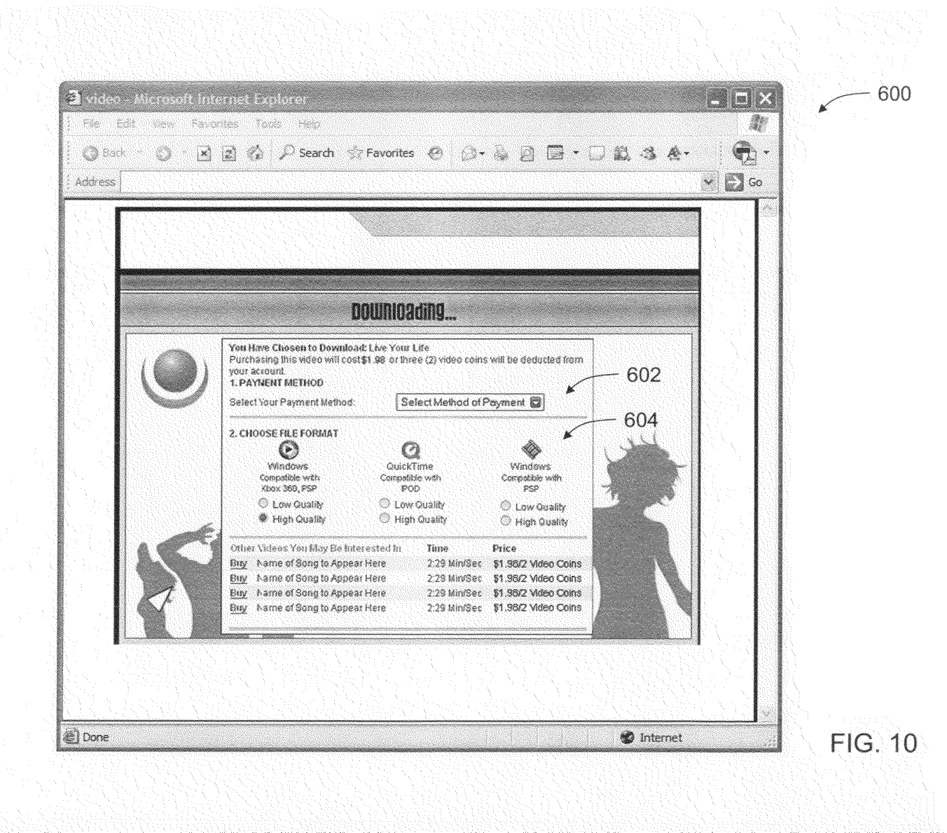

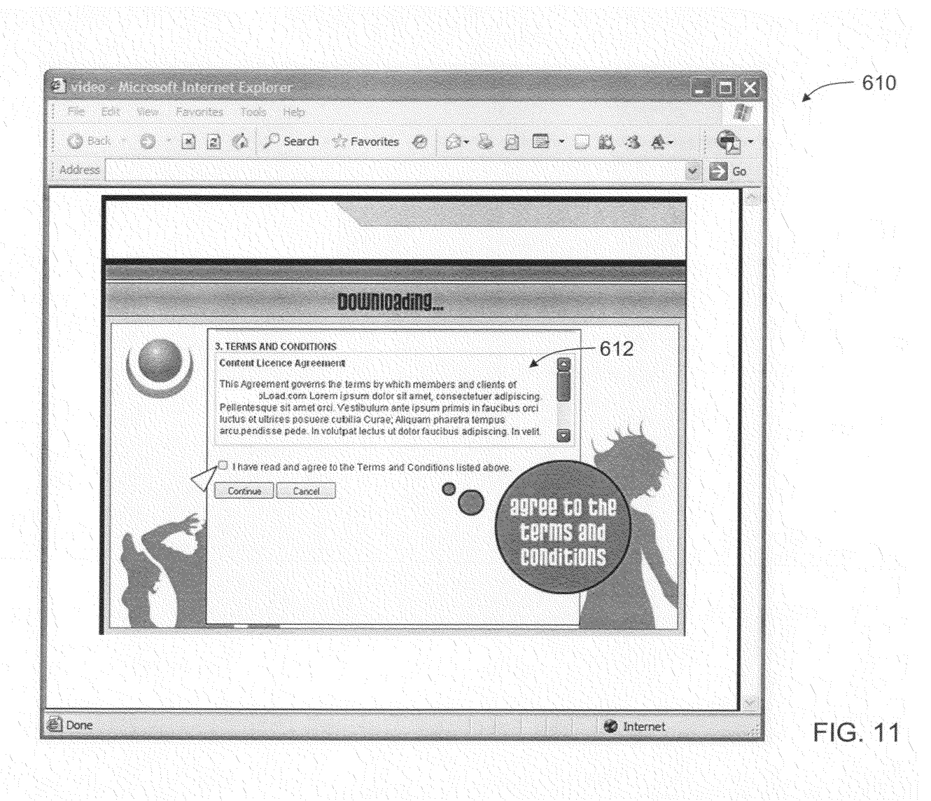

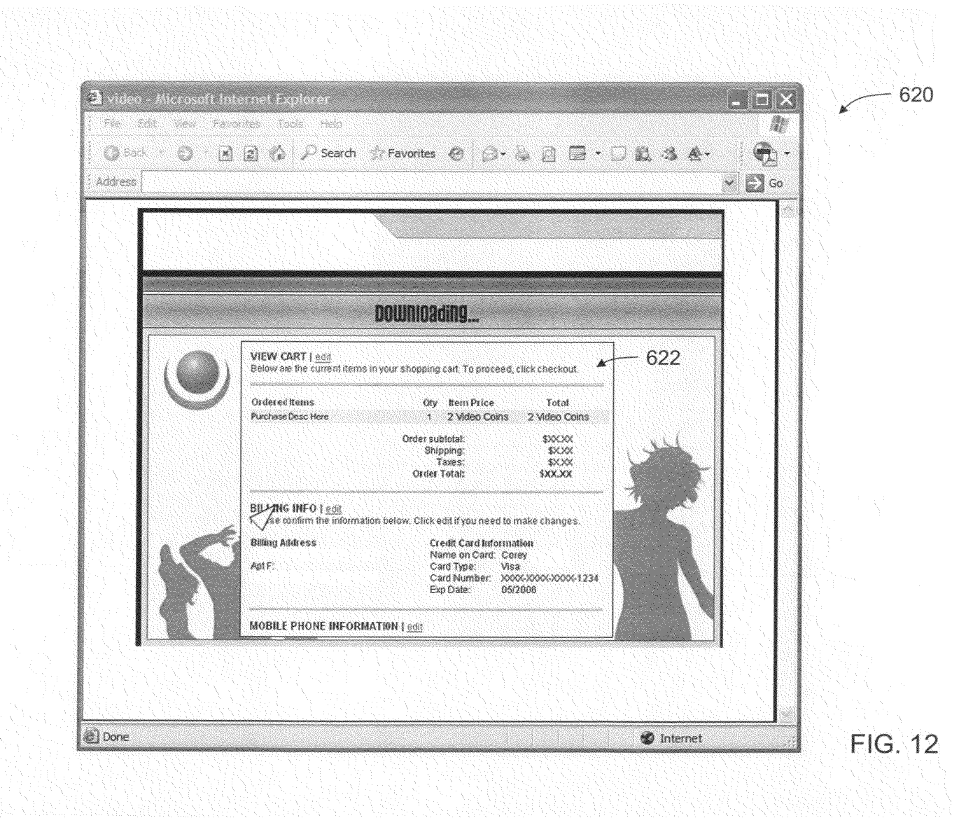

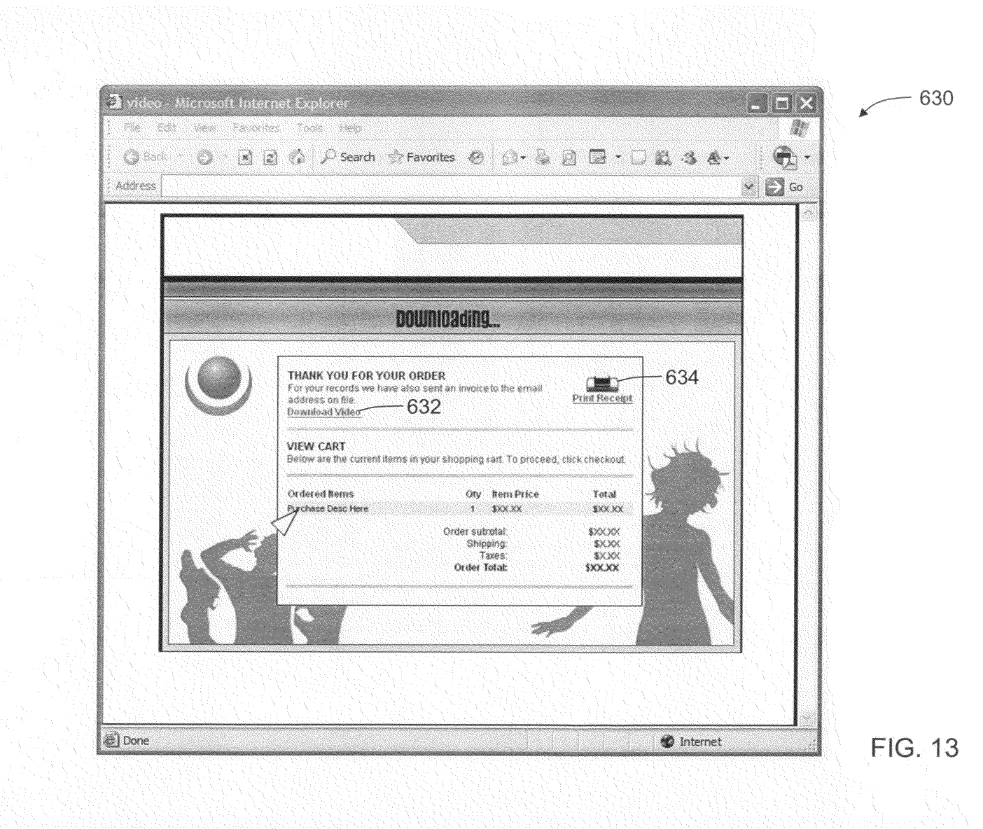

FIGS. 10-13 are example embodiments of download screens 600, 610, 620, and 630 within system 10 (shown in FIG. 1). In FIG. 10, download screen 600 includes payment method selection 602 and file format 604. In FIG. 11, download screen 610 includes terms and conditions 612. In FIG. 12, download screen 620 includes review of order 622. In FIG. 13, download screen 630 includes download 632 and print receipt 634.

Upon logging into system 10, download screens 600, 610, 620, and 630 are displayed in system 10. These screens list links to be performed or selected by the user. What is displayed on the screens for the user is reflective of the user's role in the downloading.

FIG. 10 is an example embodiment of download screen 600, which displays method of payment selection 602 and type of video file format 604. The methods of payment 602 include but are not limited to, credit card payment or video coin payment. The user selects the video file format 604 which includes various file formats, for example, MPEGs and AVIs.

FIG. 11 is an example embodiment of download screen 610, which displays terms and conditions 612 to allow a user to read and agree to the terms and conditions 612 on downloading a video file from system 10.

FIG. 12 is an example embodiment of download screen 620, which displays the order 622. The order 622, including quantity, file price, and total price, is verified by the user.

FIG. 13 is an example embodiment of download screen 630 which displays the confirmed file download 632 and the printable receipt 634. The user can select the download link 632 to download the file. The user can also select the print receipt link 634 and print the receipt for the user's records.

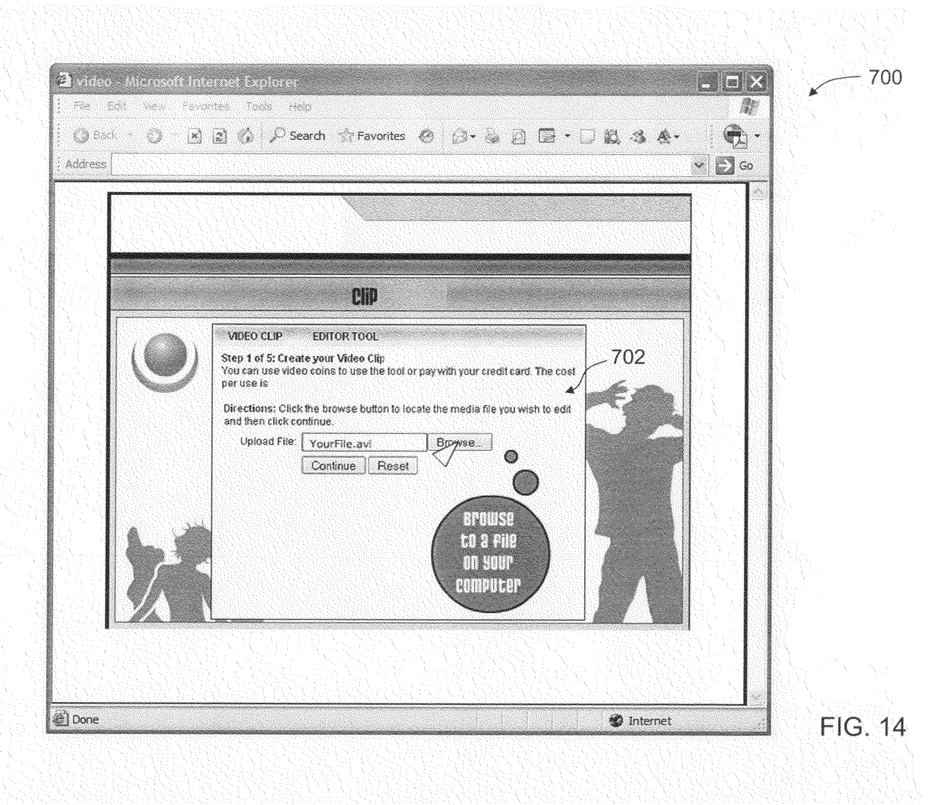

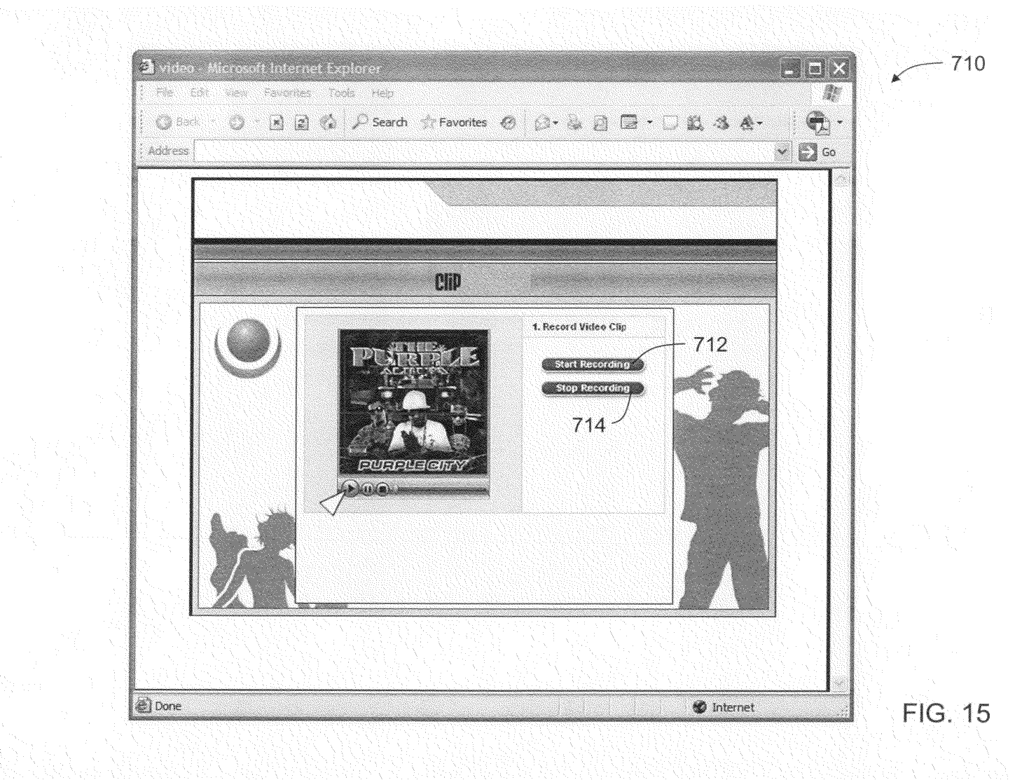

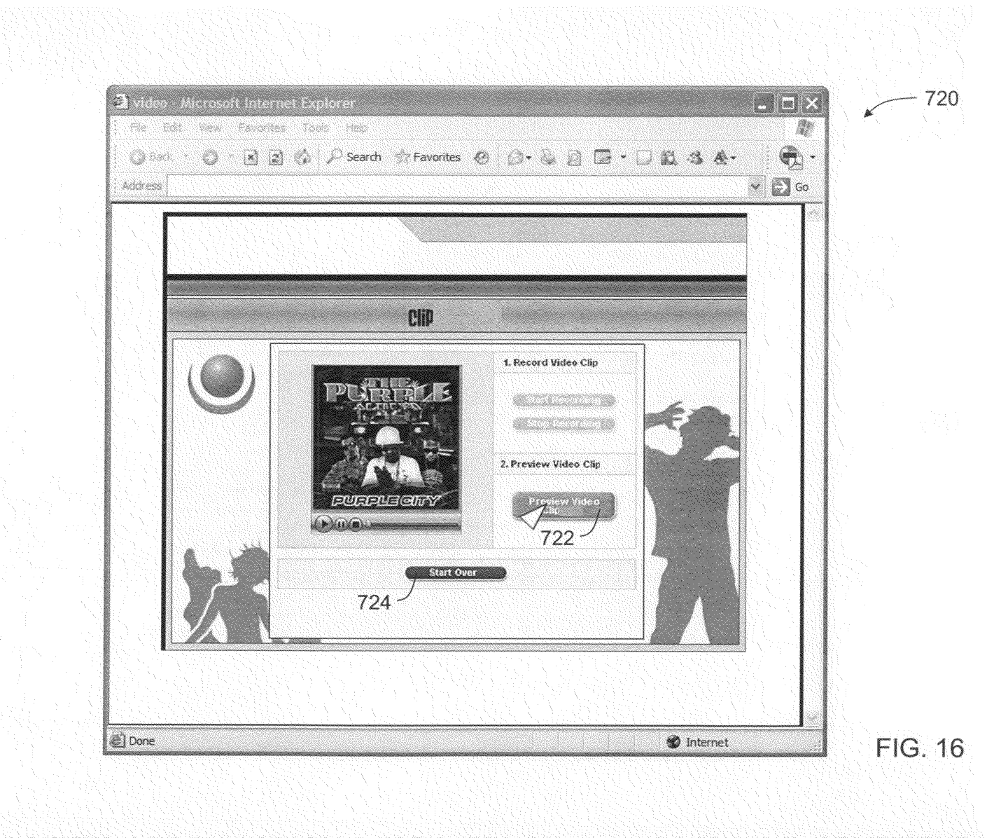

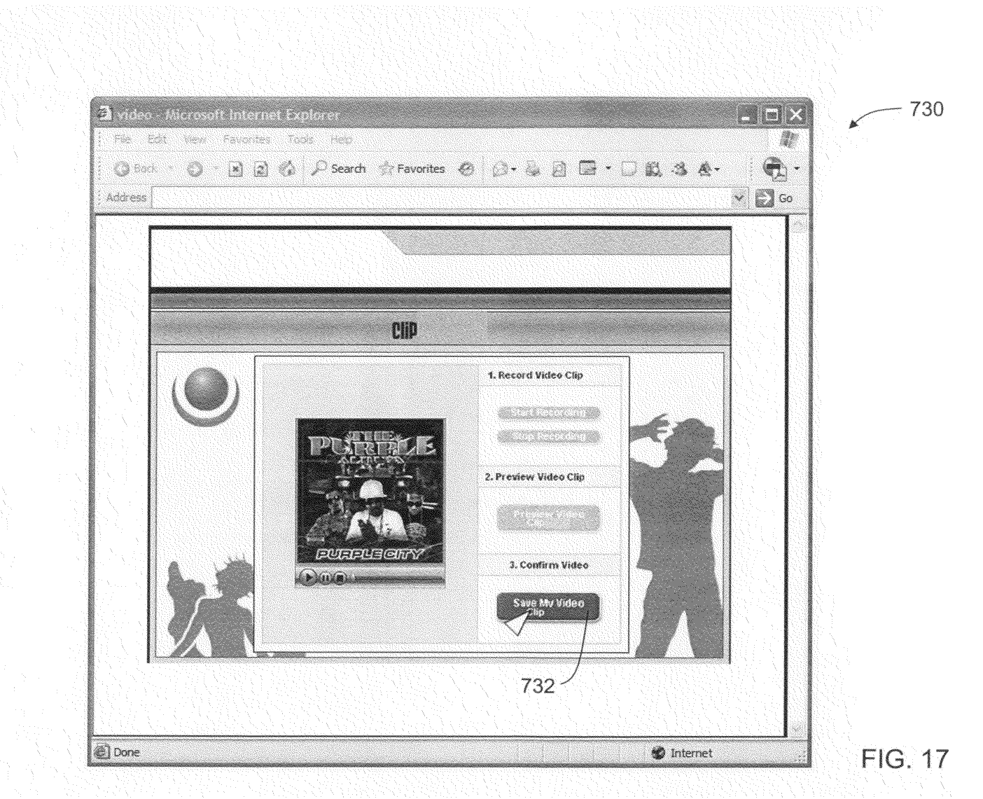

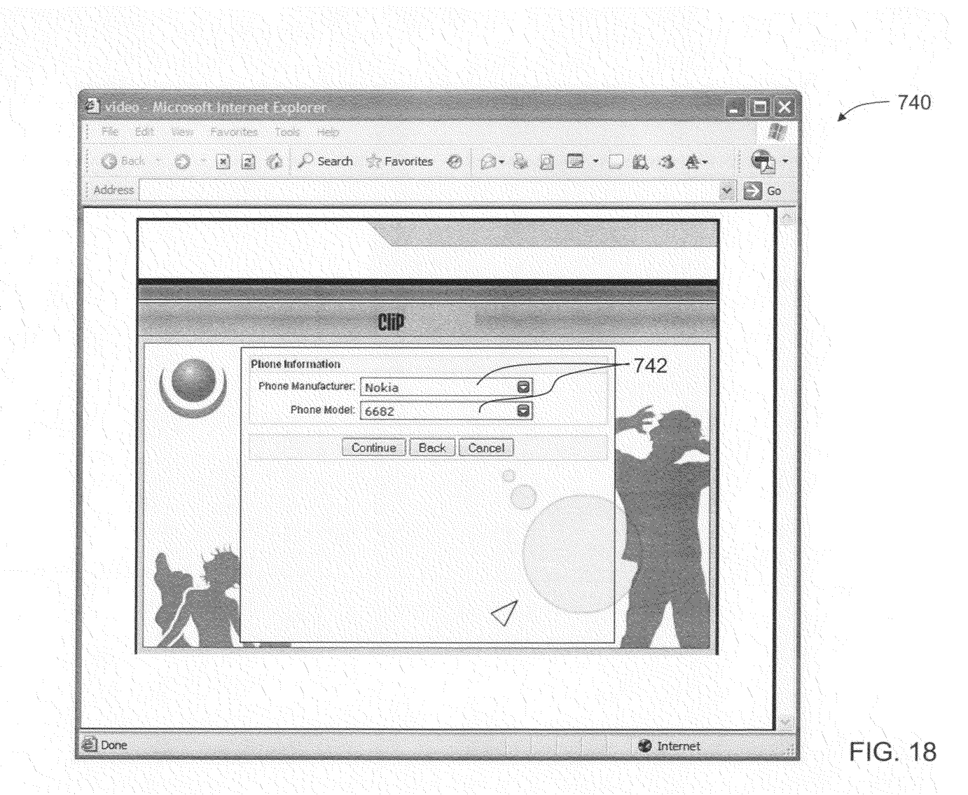

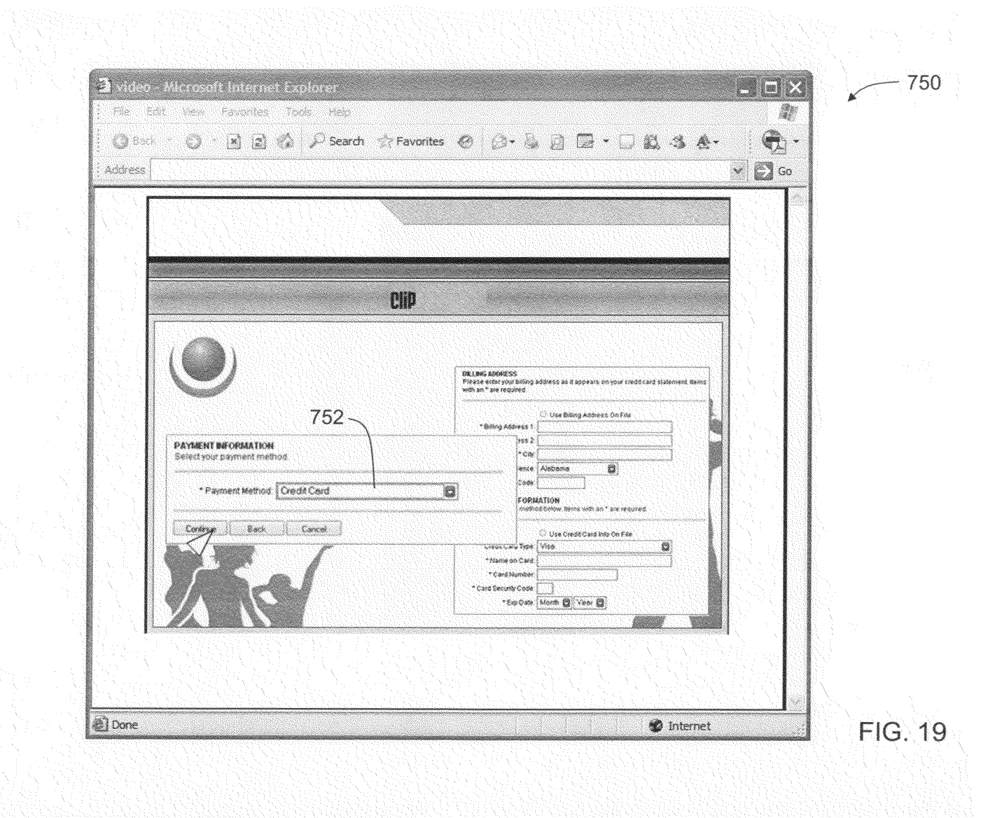

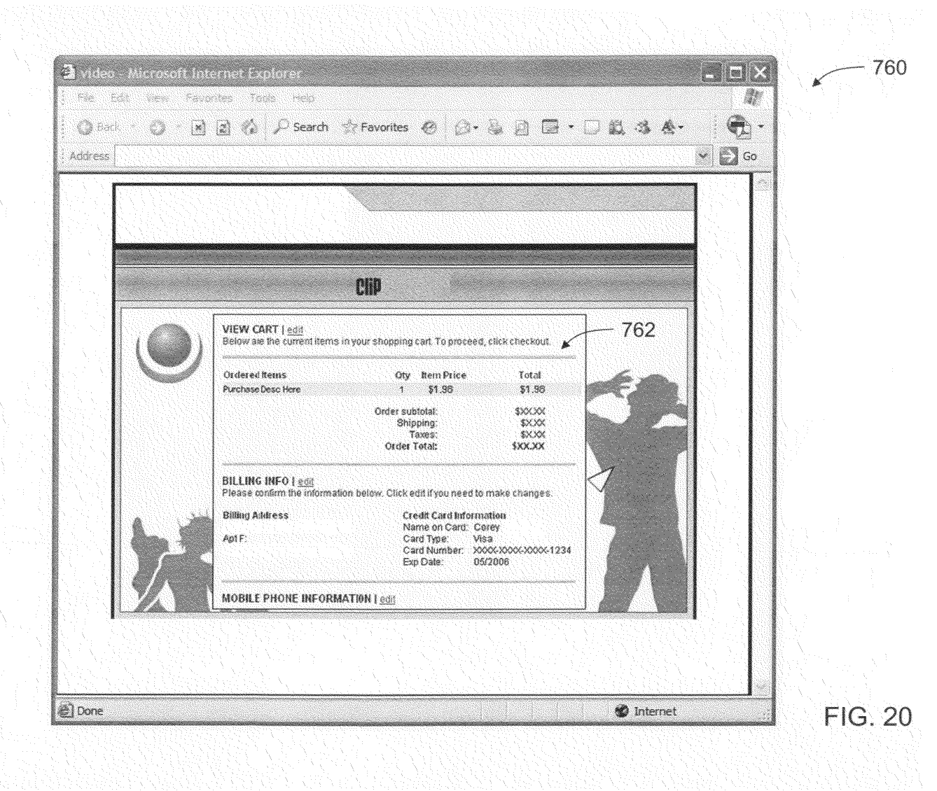

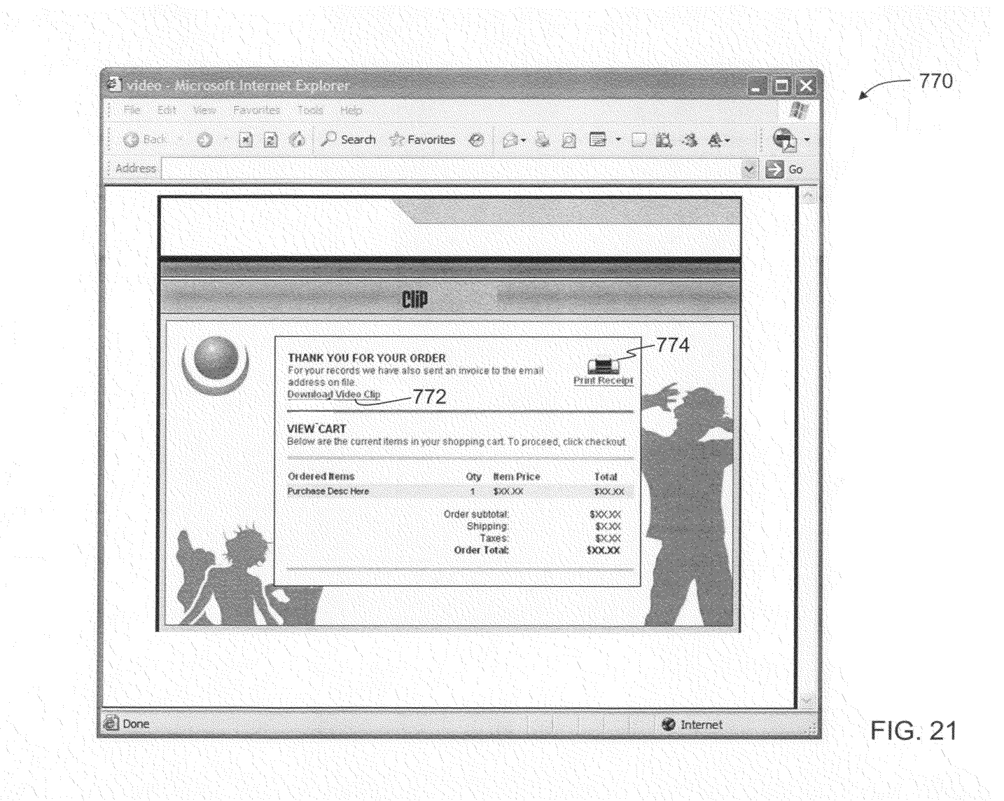

FIGS. 14-21 are example embodiments of video clip edit screens 700, 710, 720, 730, 740, 750, 760, and 770 within system 10 (shown in FIG. 1). In FIG. 14, video clip edit screen 700 includes upload video file 702. In FIG. 15, video clip edit screen 710 includes a start recording button 712 and a stop recording button 714. In FIG. 16, video clip edit screen 720 includes a video clip preview button 722 and a start over button 724. In FIG. 17, video clip edit screen 730 includes a video clip save button 732. In FIG. 18, video clip edit screen 740 includes manufacturer and model selections 742. In FIG. 19, video clip edit screen 750 includes payment method selection 752. In FIG. 20, video clip edit screen 760 includes an order 762. In FIG. 21, video clip edit screen 770 includes a download clip link 772 and a print receipt link 774.

Upon logging into system 10, video clip edit screens 700, 710, 720, 730, 740, 750, 760, and 770 are displayed. These screens list links to be performed or selected by the user. What is displayed on the screens for the user is reflective of the user's role in the uploading.

FIG. 14 is an example embodiment of video clip edit screen 700 which displays links to be performed and selected by the user. Upload file 702 allows user to upload video files into system 10, on the condition that the file is owned by the user or files that the user has the right to use in the manner in which it is being used.

FIG. 15 is an example embodiment of video clip edit screen 710 which includes the start recording button 712 and stop recording button 714 of the recording video. To capture the video clip file portion, the user plays the upload file 702 and engages start recording button 712 to start recording and engages stop recording button 714 to stop recording the video.

FIG. 16 is an example embodiment of video clip edit screen 720 which includes the preview video clip button 722. The recorded video clip can be previewed by the user to determine if the portion of the video file was obtained in the recorded clip. If the recorded portion is not the desired portion, the user can press the start over button 724 to rerecord the selection.

FIG. 17 is an example embodiment of video clip edit screen 730 which displays links to be performed and selected by the user. Video clip save button 732 allows user to save the clip to system 10.

FIG. 18 is an example embodiment of video clip edit screen 740 which the user selects the manufacturer and model 742 of the wireless mobile device to have the video clip loaded onto.

FIG. 19 is an example embodiment of video clip edit screen 750 which includes the method of payment 752. User chooses method to make payment 752, for example, a credit card or video coins.

FIG. 20 is an example embodiment of video clip edit screen 760 which includes review of the user's order 762. Order 762 shows quantity, price of each clip file and total price, as well as billing information, i.e. credit cards and video coins.

FIG. 21 is an example embodiment of video clip edit screen 770 which includes downloading clip link 772 and printing receipt link 774. In the example embodiment, the user selects the download clip link 772 and downloads the clip to a computer or device able to access the internet, and user selects the print receipt link 774 and prints receipt to show the purchase of the video clip. The video clip can also be uploaded to the system 10 in order for the user to sell.

In an alternative embodiment, system 10 is configured to allow users, such as media companies and/or movie companies that are engaged in the business of creating, managing, distributing or displaying movies and or videos, to upload video clips for purchasing by other users of system 10. These video clips can be purchased by other users and downloaded for use on mobile devices.

In another alternative embodiment, system 10 is configured to allow users, such as media companies and/or movie companies that are engaged in the business of creating, managing, distributing or displaying movies and or videos, to upload video files for purchasing by other users of system 10. In this alternative embodiment, the media company allows the purchaser of the video file to create video clips from the purchased video file. The media company grants this permission to the purchaser of the video file when the media company is the owner of the video file or in the case where the media company has permission from the owner to grant this right to the purchaser. By granting the purchaser this right, the purchaser can create video clips from the video file. In other words, these video files are purchased by a user, and the user is given permission by the owner of the video file to create a video clip therefrom. The created video clip is then downloaded for use on mobile devices.

While the invention has been described in terms of various specific embodiments, those skilled in the art will recognize that the invention can be practiced with modification within the spirit and scope of the claims.

What is claimed is:

1. A method for creating a video clip for a mobile device using a video processing system, the method comprising:
uploading at least one video file to the video processing system, the video processing system comprising a video editor module;
editing using the video editor module to produce a video clip from the video file;
saving the video clip to a video processing system database; and
downloading the video clip to a client system.

2. A method in accordance with claim 1 wherein the client system comprises a wireless mobile device and said method further comprises prompting a client to select a wireless mobile device manufacturer and model of the wireless mobile device in which the video clip is to be stored.

3. A method in accordance with claim 1 further comprising accessing a member account by creating a new account within the video processing system or signing into a previously existing member account.

4. A method in accordance with claim 1 further comprising editing the video clip after previewing the video clip.

5. A method in accordance with claim 4 wherein editing the video clip comprises rerecording a new video clip from the video file.

6. A method in accordance with claim 1 further comprising uploading the downloaded video clip from the client system to the video processing system.

7. A method in accordance with claim 6 wherein uploading the downloaded video clip further comprises uploading the downloaded video clip to sell to a buyer.

8. A method in accordance with claim 1 further comprising selecting at least one uploaded video file to download to the client system.

9. A method in accordance with claim 8 further comprising previewing the at least one uploaded video file to be downloaded to the client system.

10. A method in accordance with claim 9 further comprising selecting a file format of the at least one uploaded video file to be downloaded to the client system.

11. A method in accordance with claim 1 wherein uploading the at least one video file comprises uploading the at least one video file to sell to a buyer.

12. A network-based system for creating a video clip for a mobile device, the network-based system comprising:
a client system including a browser;
a video processing system database for storing information; and
a video processing system communicatively coupled to the client system and the video processing system database, the video processing system comprising a video editor module for editing video files, the video processing system configured to:
upload at least one video file to the video processing system;
edit the video file using the video editor module to produce a video clip from the video file;
save the video clip to the video processing system database; and
download the video clip to the client system.

13. A network-based system in accordance with claim 12 wherein the client system comprises a wireless mobile device, the video processing system firther configured to prompt a client to select a wireless mobile device manufacturer and model of the wireless mobile device in which the video clip is to be stored.

14. A network-based system in accordance with claim 12 wherein the video processing system is further configured to access a member account by creating a new account within the video processing system or signing into a previously existing member account.

15. A network-based system in accordance with claim 14 wherein the video processing system is further configured to rerecord a new video clip from the video file.

16. A network-based system in accordance with claim 12 wherein the video processing system is further configured to upload the downloaded video clip from the client system to the video processing system.

17. A network-based system in accordance with claim 16 wherein the video processing system is further configured to upload the downloaded video clip to sell to a buyer.

18. A network-based system in accordance with claim 12 wherein the video processing system is further configured to select at least one uploaded video file to download to the client system.

19. A network-based system in accordance with claim 18 wherein the video processing system is further configured to preview the at least one uploaded video file to be downloaded to the client system.

20. A network-based system in accordance with claim 19 wherein the video processing system is further configured to select a file format of the at least one uploaded video file to be downloaded to the client system.

21. A network-based system in accordance with claim 12 wherein the video processing system is further configured to upload the at least one video file to sell to a buyer.

22. A server system for creating a video clip for a mobile device, the server system communicatively coupled to a client system and a video processing system database, the server system configured to:
upload at least one video file to a video processing system comprising a video editor module;
edit using the video editor module to produce a video clip from the video file;
save the video clip to the video processing system database; and
download the video clip to the client system.
